(19) United States
(12) Patent Application Publication
(10) Pub. No.: US 2003/0221565 A1
(43) Pub. Date: Dec. 4, 2003

(54) Apparatus for cooking chickens, geese, ducks, turkeys, birds or other fowl in a vertical position

(76) Inventor: Danny M. Finke, Spring, TX (US)

Correspondence Address: William E. Johnson, Jr., THE MATTHEWS FIRM, Suite 1800, 1900 West Loop South, Houston, TX, 77027, US

(21) Appl. No.: 10/158,079

(22) Filed: May 29, 2002

(51) Int. Cl. A47J 37/04

(52) U.S. Cl. 99/419

(57) ABSTRACT

A stainless steel cylinder having a 2″ outside diameter and which is 6″ long is welded at its lower end to a flat plate residing in a plane which is 90° from the longitudinal axis of the cylinder, and which has an outer perimeter in the design of the State of Texas. In the process of cooking a chicken or other fowl, the interior of the cylinder is filled with beer, or wine and/or water, which also has various spices according to taste. In the cooking process, the flat plate to which the cylinder is welded is placed on a Bar-B-Que grill, and the cylinder is inserted into the body cavity of the chicken. In a first alternative mode, a circular plate or plug is forced into the lower end of the cylinder to create a hermetic seal and closure of the cylinder. In a second alternative mode, the cylinder is fabricated from a solid, stainless steel rod having a 2″ diameter and an interior rod cavity bored along the longitudinal axis of the rod, but stopping just short of the lower end of the rod to ensure that the fluid added to the cylinder does not leak. As the liquid within the cylinder heats up in the cooking process, the steam from the liquid, with all of the spices therein, are forced into the body cavity of the fowl being cooked.

### AREA OF TECHNOLOGY

This invention relates, generally, to cooking chicken, turkeys, or other fowl in a vertical position, and specifically, to methods and apparatus for forcing spicy steam into the body cavity of such fowl in the vertical position during the cooking process.

### BRIEF DESCRIPTION OF THE DRAWINGS

FIG. 1 is an elevated, pictorial view of a fowl cooker according to the invention; and

FIG. 2 is an elevated, pictorial view of the cooker illustrated in FIG. 1, in which the cylinder of the cooker is residing within the body cavity of a chicken, and the base member of the cooker is resting upon a grill of a Bar-B-Que grill.

### DETAILED DESCRIPTION OF THE PREFERRED EMBODIMENT

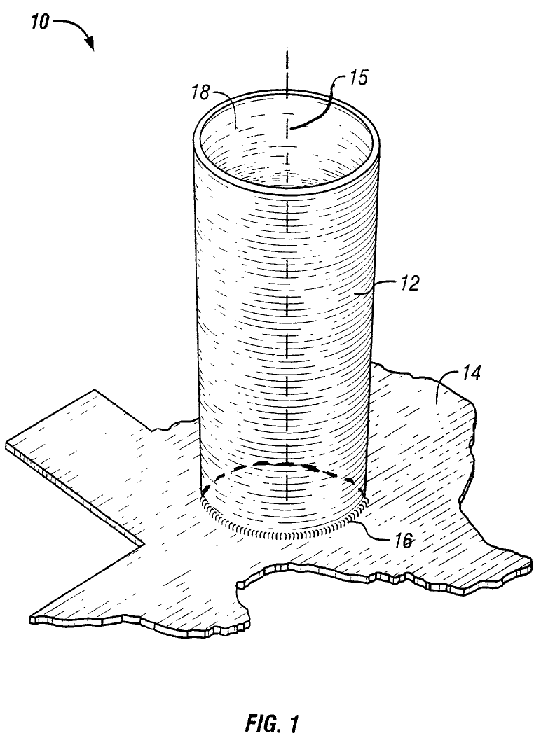

Referring now to FIG. 1, there is illustrated an elevated, pictorial view of the fowl cooker 10 having a stainless steel cylinder 12 and a stainless steel base member 14 which may be configured in various designs, shapes and sizes, but which preferably comprises a flat plate having a thickness of approximately 1/16,″ a span of approximately four to six inches, and whose outer perimeter is a design of the State of Texas.

The cylinder 12 has a length in the range of 4-7 inches, preferably is 5-6 inches long, and more preferably is six inches long, and preferably has an external diameter of 2 inches. The thickness of the wall of the cylinder 12 may vary, but preferably is 1/16″ thick.

The stainless steel cylinder 12 is welded to the stainless steel base member 14, which can be accomplished in one of two ways. Preferably, the lower, open end 16 of the cylinder 12 is welded directly to the stainless steel base member 14.

It is very important that the weld connection be accomplished appropriately, to create a hermetic seal between the cylinder 12 and the base member 14, to preclude any liquids placed within the cylinder 12 from leaking out.

Alternatively, if desired, the cylinder 12 may already have, at its own lower end, a circular, leak proof plate secured in place, prior to welding the cylinder 12 to the base plate 14. A circular plate or plug can, for example, be forced into the lower end of the cylinder to create a hermetic seal and closure of a cylinder. The lower end plate of the cylinder can be secured in place in many ways, for example, through casting, forging, welding, or any other way well-known in connecting two stainless steel parts. Alternatively, the cylinder 12 can originate from a solid stainless, 2″ rod, into which a bore is drilled along its longitudinal axis 15, stopping just short of the lower end of the cylinder 12, to leave a bottom end plate which is 1/16″ to ¼″ thick, thus eliminating any substantial risk of liquid leaking out of the cylinder 12. With each embodiment herein described, the longitudinal axis 15 of cylinder 12 is perpendicular to the base member 14.

Whatever the case, as variously discussed above, the cylinder 12 is then welded to the base member 14. The longitudinal axis of the cylinder 12 is oriented to be 90° from the plane of the base member 14. Because the base member 14 will be placed upon a Bar-B-Que grill which is essentially horizontal, the cylinder 12 will be essentially vertical and the chicken or other fowl which is cooked upon cylinder 12 will be essentially vertical. The base member 14 may be of various other shapes, for example, any of the other States of the United States of America, or even the outline of the entire United States of America, or of the lower 48 States.

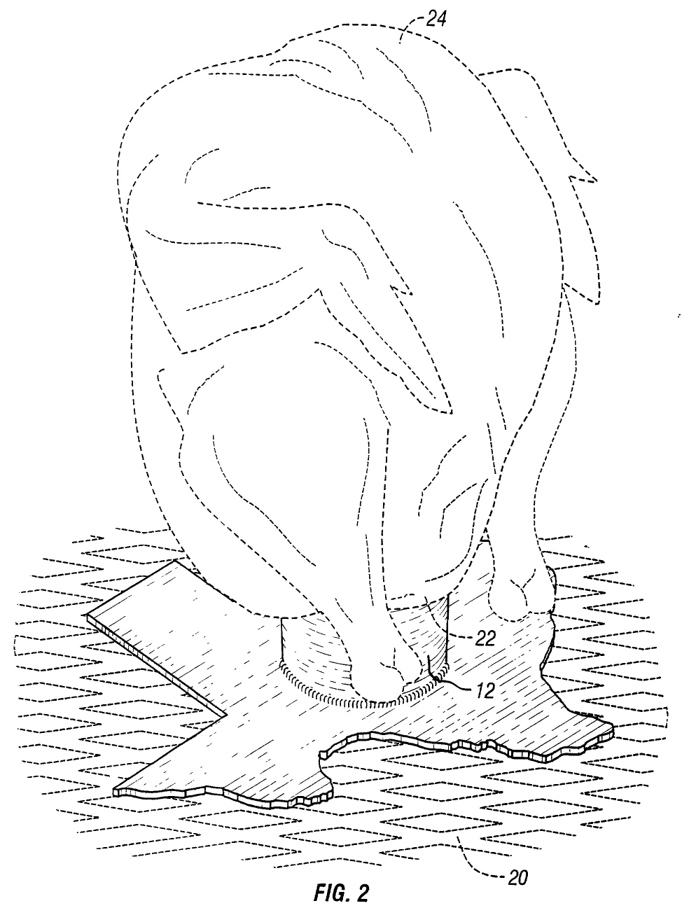

In use, the base plate 14 is positioned upon a Bar-B-Que grill 20, illustrated in FIG. 2, and various fluids (beer, water, oil, etc.) are added into the top, open end 18 of the cylinder 12, along with spices as desired. The cylinder 12 is then placed into the body cavity 22 of the chicken 24, or other fowl, to allow the cooking to start. The cooking process can take place on an outdoor Bar-B-Que grill, or in an indoor baking and/or broiler oven. When using in an indoor oven, it is preferable to place the cooker 10 illustrated in FIG. 1 in a baking pan to catch the drippings. The cylinder 12 and the base member 14 will get very hot, so a cooking glove or mitt should be used to avoid burning one's hands. Liquids that are highly flammable such as liqueurs or other liquors, should not be used inside the cylinder 12 because of the danger of fire. As the liquid within the cylinder heats up in the cooking process, the steam from the liquid, with all of the spices therein, are forced into the body cavity of the fowl being cooked.

In but one example of the use of the cooker 10 to cook a chicken, one can add 1 tablespoon of minced onion, 1 teaspoon of Lawry's Seasoned Salt, 1 teaspoon of garlic powder and ½ teaspoon of black pepper to 6 ounces of beer, and pour the mixture into the top, open end 18 of cylinder 12. The outside of the chicken can be rubbed down with Tony Chachere's Original Seasoning. Lawry's Seasoned Salt is available from Lawry's Foods, Inc. of Monrovia, Calif. 91016. Tony Chachere's Original Seasoning is available from Tony Chachere's Creole Foods of Opelousas, Inc. of Opelousas, La. 70571-1639.

After the outside of the chicken 24 has been rubbed down, and the beer/spices mixture is poured into the cylinder 12, the cylinder 12 is inserted into the body cavity 22 of the chicken 24 and the combined cooker/chicken 10, 24 is placed on the Bar-B-Que grill 20 as illustrated in FIG. 2

1. A cooking apparatus comprising:
a metal base place; and
a metal cylinder having first and second ends, with said first end being welded to said base plate, in which the longitudinal axis of said cylinder is oriented 90° from the plane of said base plate, and the second end of said cylinder is open for receiving fluids and spices.

2. The apparatus according to claim 1, wherein said base plate and said cylinder each comprise stainless steel.

3. The apparatus according to claim 1, wherein said base plate has an outer perimeter which is a design of the State of Texas.

4. The apparatus according to claim 1, wherein the first end of said cylinder is hermetically closed and sealed prior to being welded to the base plate.

5. The apparatus according to claim 1, wherein the first end of said cylinder is hermetically closed and sealed to said base plate as a result of being welded to said base plate.

6. The apparatus according to claim 1, wherein said cylinder is fabricated by boring an elongated cavity in a solid rod having first and second ends, along the longitudinal axis of said rod, wherein said cavity commences at the second end of said rod and stops just short of the first end of said rod.
